(19) United States
(12) Patent Application Publication
(10) Pub. No.: US 2026/0124826 A1
(43) Pub. Date: May 7, 2026

(54) HIGH ENERGY PROTECTIVE LAMINATES

(71) Applicants: W. L. Gore & Associates, Inc., Newark, DE (US); W. L. Gore & Associates GmbH, Putzbrunn (DE)

(72) Inventors: Mustafa Arifoglu, Newark, DE (US); Bernd Zischka, Putzbrunn (DE); Miguel Calixto, Putzbrunn (DE)

(21) Appl. No.: 19/117,785

(22) PCT Filed: Oct. 2, 2023
(86) PCT No.: PCT/US2023/075732

§ 371 Date: Apr. 2, 2025

Related U.S. Application Data
(60) Provisional application No. 63/378,180, filed on Oct. 3, 2022.

(51) Int. Cl. B32B 27/12; B32B 5/02; B32B 7/14; B32B 27/32; B32B 37/04; B32B 37/12; B32B 38/00

(52) U.S. Cl. CPC B32B 27/12; B32B 5/024; B32B 5/026; B32B 7/14; B32B 27/322; B32B 37/04; B32B 37/1292; B32B 38/145; B32B 2250/03; B32B 2250/40; B32B 2264/108; B32B 2264/203; B32B 2307/212; B32B 2307/3065; B32B 2571/00

(57) ABSTRACT

The present disclosure relates to flame retardant laminates that can be used to make flame retardant textiles and flame retardant garments. The laminates described herein allow the use of non-flame retardant textiles to produce the flame retardant laminates. This use of non-flame retardant textile can provide laminates that can be much lighter in weight, more comfortable against the skin, more breathable, more durable, produced in a wider array of colors, have better moisture management properties, mechanical strength, and more environmentally friendly than flame retardant laminates that use inherently flame retardant textiles.

### TECHNICAL FIELD OF THE DISCLOSURE

The present disclosure relates to light weight protective laminates comprising multiple textile layers. In particular, the protective laminates can provide protection from flash fires and the discharge of an electric arc.

### BACKGROUND OF THE DISCLOSURE

In order to reduce injuries, protective laminates and clothing is desired for professional working in hazardous environments where short duration exposure to flames or electric arc flash is possible. Protective gear for workers exposed to these conditions should provide some enhanced protection to allow the wearer to get away from the hazard quickly and safely, rather that repair the hazard.

Traditionally, garments that provide protection from an exposure to a short duration flash fire or an electrical flash are relatively heavy and require multiple layers, each layer providing an additional level of protection against the heat from the exposure. Such garments are made with multiple layers of comprising non-combustible, non-melting fabric made of, for example, aramids, polybenzimidazole (PBI), poly p-phenylene-2,6-benzobisoxazole (PBO), modacrylic blends, polyamines, carbon, polyacrylonitrile (PAN), and blends and combinations thereof. These fibers may be inherently flame resistant and are often used in the firefighting community but have several limitations. Specifically, in order to achieve the desired level of protection, relatively heavy weight, bulky fabrics are required. Typically, these fabrics can have a basis weight in excess of 400 grams per square meter. The fibers used to form these fabrics may be very expensive, difficult to dye and print, and may not have adequate abrasion resistance. Additionally, these fibers pick up more water and offer unsatisfactory tactile comfort as compared to nylon or polyester based fabrics. For optimum user performance in environments with a potential arc flash exposure, a lightweight, breathable, water resistant garment with enhanced burn protection may be desired. The is a continuing need for waterproof, flame resistant (FR), arc flash resistant, protective clothing that minimizes or eliminates the use of typical non-combustible, non-melting fabric textiles such as those used in firefighting community.

### SUMMARY OF THE DISCLOSURE

In a first embodiment, the present disclosure relates to laminates comprising a) a first textile layer; b) a first layer of a heat reactive material; c) a carrier layer; d) a second layer of heat reactive material; and e) a second textile layer. In the embodiments described herein, the first and second layer of heat reactive material each independently comprise a polymer resin and expandable graphite. Additionally, the first layer of heat reactive material is located between the first textile layer and the carrier layer and the second layer of heat reactive material is located between the carrier layer and the second textile layer.

In a second embodiment, each layer of heat reactive material is independently applied in a continuous manner or a discontinuous manner.

In any of the previous embodiments, each layer of the heat reactive material can be in the form of a pattern of discontinuous dots, lines or grids.

In any of the previous embodiments, at least one of the first and the second layer of heat reactive material comprises a flame retardant additive.

In any of the previous embodiments, the first textile layer, comprises or consists essentially of meltable fibers. In any of the previous embodiments, the first textile layer comprises or consists essentially of nonmeltable fibers. In any of the previous embodiments, the first textile layer comprises or consists essentially of a mixture of meltable and nonmeltable fibers.

In any of the previous embodiments, the first textile layer can comprise in the range of from 0% to 100% meltable fibers, based on the total weight of the meltable and nonmeltable fibers in the first textile layer. In other embodiments, the first textile layer can comprise in the range of from greater than 0% to 100% meltable fibers, or from 0.5% to 100% meltable fibers, or from 1% to 100%, or from 1% to 99% meltable fibers, or from 3% to 100% meltable fibers, or from 5% to 100% meltable fibers, or from 10% to 100% meltable fibers, or from 20% to 100% meltable fibers, or from 25% to 100% meltable fibers, or from 30% to 100% meltable fibers, or from 35% to 100% meltable fibers, or from 40% to 100% meltable fibers, or from 50% to 100% meltable fibers, or from 60% to 100% meltable fibers, or from 70% to 100% meltable fibers, or from 80% to 100% meltable fibers, or from 90% to 100% meltable fibers. In other embodiments, the first textile comprises a combination of meltable and nonmeltable fibers in the range of from 1 to 99% nonmeltable fibers and from 1 to 99% meltable fibers, wherein the percentages by weight are based on the total weight of the fibers in the first textile layer. Each of the percentages are based on the total weight of the fibers in the first textile layer.

In some of the previous embodiments, the first textile layer can comprise a 100% nylon textile. In some of the previous embodiments, the first textile layer can be a 100% polyester textile. In still further embodiments, the first textile layer can comprise in the range of from 30% to 70% nylon and 30% to 70% cotton; or from 30% to 68% nylon and from 30% to 68% cotton, and up to about 5% by weight, based on the total weight of the textile of an antistatic additive; or from 30% to 70% polyester and 30% to 70% cotton; or from 30% to 68% polyester and from 30% to 68% cotton, and up to about 5% by weight, based on the total weight of the textile of an antistatic additive. In other embodiments, the first textile layer can be a cotton textile comprising up to 100% cotton. In other embodiments, the first textile layer can be a wool textile comprising up to 100% wool.

In any of the previous embodiments, the second textile layer comprises or consists essentially of meltable fibers. In any of the previous embodiments, the second textile layer comprises or consists essentially of nonmeltable fibers. In any of the previous embodiments, the second textile layer comprises or consists essentially of a mixture of meltable and nonmeltable fibers.

In any of the previous embodiments, the second textile layer can comprise in the range of from 0% to 100% meltable fibers, based on the total weight of the meltable and nonmeltable fibers in the second textile layer. In other embodiments, the second textile layer can comprise in the range of from greater than 0% to 100% meltable fibers, or from 0.5% to 100% meltable fibers, or from 1% to 100%, or from 1% to 99% meltable fibers, or from 3% to 100% meltable fibers, or from 5% to 100% meltable fibers, or from 10% to 100% meltable fibers, or from 20% to 100% meltable fibers, or from 25% to 100% meltable fibers, or from 30% to 100% meltable fibers, or from 35% to 100% meltable fibers, or from 40% to 100% meltable fibers, or from 50% to 100% meltable fibers, or from 60% to 100% meltable fibers, or from 70% to 100% meltable fibers, or from 80% to 100% meltable fibers, or from 90% to 100% meltable fibers. In other embodiments, the second textile comprises a combination of meltable and nonmeltable fibers in the range of from 1 to 99% nonmeltable fibers and from 1 to 99% meltable fibers, wherein the percentages by weight are based on the total weight of the fibers in the second textile layer. Each of the percentages are based on the total weight of the fibers in the second textile layer.

In some of the previous embodiments, the second textile layer can comprise a 100% nylon textile. In other embodiments, the second textile layer can be a 100% polyester textile. In still further embodiments, the second textile layer can comprise in the range of from 30% to 70% nylon and 30% to 70% cotton; or from 30% to 68% nylon and from 30% to 68% cotton, and up to about 5% by weight, based on the total weight of the textile of an antistatic additive; or from 30% to 70% polyester and 30% to 70% cotton; or from 30% to 68% polyester and from 30% to 68% cotton, and up to about 5% by weight, based on the total weight of the textile of an antistatic additive; or from 40% to 60% nylon and from 40% to 60% cotton, and up to about 5% by weight, based on the total weight of the textile of an antistatic additive; or from 30 to 68% of an aramid and from 30 to 68% of a flame retardant viscose with up to about 5% of an antistatic additive. In other embodiments, the second textile layer can be a cotton textile comprising up to 100% cotton. In other embodiments, the second textile layer can be a wool textile comprising up to 100% wool.

In any of the previous embodiments, the layers a) and c) are bonded to each other using the first layer of heat reactive material and the layers c) and e) are bonded to each other using the second layer of heat reactive material.

In any of the previous embodiments, the first layer of heat reactive material covers greater than or equal to 25% of the first textile layer and/or the carrier layer.

In any of the previous embodiments, the second layer of heat reactive material covers greater than or equal to 25% of the second textile layer and/or the carrier layer.

In any of the previous embodiments, the expandable graphite expands at least about 900 micrometers upon heating to about 280° C., as measured in the TMA expansion test.

In any of the previous embodiments, the carrier layer comprises a film, a textile or a combination thereof. In some embodiments, the carrier layer can be a film, for example, a film comprising fluoropolymer, polyimide, silicone, polyurethane, polytetrafluoroethylene (PTFE), expanded PTFE (ePTFE) or a combination thereof. In any of the previous embodiments, the carrier layer can be a nonwoven textile, for example an aramid nonwoven. In other embodiments, the carrier layer can be a laminate of one or more films and one or more textiles. In some embodiments, the carrier layer can comprise a meltable film or a nonmeltable film, a textile or a combination thereof.

In any of the previous embodiments, the laminate may further comprise one or more additional layers of heat reactive material and one or more additional layers of textile layers, wherein each subsequent additional layer is positioned adjacent to at least one of the first and/or second textile layers.

The present disclosure also relates to a method of forming a laminate comprising; i) adhering a first textile layer to a carrier layer with a first heat reactive material to form a precursor laminate; and ii) adhering the precursor laminate to a second textile layer with a second heat reactive material, wherein the first and second heat reactive materials independently comprise a polymer resin and expandable graphite.

In any of the previous embodiments, the laminates can be used in a protective article, wherein the first textile layer is an outer portion of the protective article, when compared with the second textile layer, which forms an inner portion of the protective article. The protective articles can include, for example, garments such as shirts, jackets, pants, coveralls, overalls, aprons, hats, gloves and footwear; covers, blankets, tents.

The present disclosure also relates to the use of any of the previously described laminates to increase the thermal protective performance of a protective article comprising the laminate against an arc discharge of up to 100 cal/cm², when compared to a protective article that does not use the first and second layers of heat reactive material.

The disclosure relates to a garment comprising the laminate of any one of the previous embodiments.

Laminates according to the present disclosure are useful for use as flame retardant articles, for example, as a flame retardant garment, a flame retardant blanket, or a flame retardant cover. Typically, flame retardant garments were required to use flame retardant textiles to make the flame retardant garments. The laminates described herein allow the use of non-flame retardant textiles to produce the laminates. This use of non-flame retardant textile can provide laminates that can have one or more of the following benefits. The laminates can be much lighter in weight, more comfortable against the skin, more breathable, more durable, produced in a wider array of colors, have better moisture management properties, mechanical strength, and more environmentally friendly. The disclosed laminates can also help to reduce the environmental footprint by utilize recycled components in the textile layers which makes products that have a lower MSI HIGG index.

### DESCRIPTION OF THE DRAWINGS

FIG. 1 is a schematic illustration of a cross-sectional view of one embodiment described herein.

FIG. 2 is a schematic illustration of a cross-sectional view of one embodiment described herein.

FIGS. 3A and 3B are schematic illustrations of laydowns of the heat reactive material according to two different embodiments.

FIG. 4 are schematic illustrations of overlapping, partially overlapping and non-overlapping dots of heat reactive material.

### DETAILED DESCRIPTION

The disclosures of all cited patent and non-patent literature are incorporated herein by reference in their entirety.

As used herein, the term “embodiment” or “disclosure” is not meant to be limiting, but applies generally to any of the embodiments defined in the claims or described herein. These terms are used interchangeably herein.

Unless otherwise disclosed, the terms “a” and “an” as used herein are intended to encompass one or more (i.e., at least one) of a referenced feature.

The features and advantages of the present disclosure will be more readily understood, by those of ordinary skill in the art from reading the following detailed description. It is to be appreciated that certain features of the disclosure, which are, for clarity, described above and below in the context of separate embodiments, may also be provided in combination in a single element. Conversely, various features of the disclosure that are, for brevity, described in the context of a single embodiment, may also be provided separately or in any sub-combination. In addition, references to the singular may also include the plural (for example, “a” and “an” may refer to one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including each and every value between the minimum and maximum values.

As used herein, the terms “fiber”, “filament” and “yarn” may be used interchangeably, unless specifically stated otherwise. A fiber is intended to mean a thin thread having a finite length, for example, from a few millimeters to about 30 centimeters in length. The term “filament” is intended to mean a thin thread having an essentially endless length. A filament may be thousands of meters long. The term “yarn” means a continuous strand comprising one or more fibers and/or filaments. Any of the known yarns can be used, for example, single-ply yarns, plied yarns, cord yarns, stretch yarns or any combinations thereof. Fibers and/or filaments can be used to make the yarns.

As used herein, the term “meltable”, when used in relation to a fiber, a filament, a yarn, or a textile, means a fiber that melts at less than or equal to 280° C. or less than or equal to 300° C. In embodiments wherein the yarn or textile is made from a singular material, for example, 100% nylon 6, the melting point of the material is the melting point of the nylon 6. However, in yarn or textile embodiments comprising a mixture of both meltable and non-meltable fibers, the presence of the non-meltable component may mask the melting of the meltable material. For example, in the case of a textile comprising a 50/50 blend of nylon 6.6 and cotton, the melting nylon 6.6 may be absorbed by the cotton component and, when subjected to the melting and thermal stability test described herein, may appear to show that the textile sample is not meltable. Therefore, when there is a meltable fiber present in a blend of meltable and non-meltable fibers, the material will be considered to be a meltable material for the purposes of this disclosure.

The disclosure describes textiles that are used in various layers of the laminate. As used herein, each of the first and second textile layers can independently be a single layer or a multilayer textile in a woven, knit or nonwoven form. Textiles are produced from fibers, filaments and/or yarns that can be meltable, nonmeltable, or a combination thereof. The fibers, filaments or yarns can be synthetic and/or natural. Depending upon the type and the compositions of the fibers, filaments or yarns, the corresponding textiles can have a variety of different properties. The textiles can be meltable, nonmeltable, flammable, flame-resistant, abrasion-resistant, heat-resistant, shrink-resistant or the textiles can have a combination of those properties. As use herein, the term “shrink-resistant” means that the textiles and/or laminates shrink less than 20% or less than 10% or less than 5% of their width, their length or both, when exposed to a high energy event. As used herein, the term “high energy” or “high energy event” means an exposure of greater than or equal to 0.1 seconds to a temperature of greater than or equal to 180° C. In other embodiments, the laminates described herein shrink less than 20% or less than 10% or less than 5% when subjected to the shrink test according to ISO 17493 at 180° C. In other embodiments, the laminates described herein shrink less than 20% or less than 10% or less than 5% when subjected to the shrink test according to ISO 17493 at 260° C.

Described herein are laminates having a) a first textile layer, b) a first layer of a heat reactive material, c) a carrier layer, d) a second layer of heat reactive material and e) a second textile layer, wherein the first and second layers of heat reactive material each independently comprise a polymer resin and expandable graphite; wherein the first layer of heat reactive material is between the first textile layer and the carrier layer and the second layer of heat reactive material is between the carrier layer and the second textile layer. The laminates can be used to make protective articles, including protective clothing, wherein the first textile layer is typically the outermost layer of the garment, and the second textile layer is an inner layer of the garment. Protective articles can include, for example, clothing, garments, tents, blankets, and/or coverings. Protective clothing includes garments like jackets, trousers, shirts, vests, overalls as well as gloves, gaiters, hoods, footwear and shoes. Protective clothing comprising the laminates may be waterproof or water resistant, and breathable. Protective clothing needs to be lightweight to be widely used, especially in cases where the danger of an exposure to a flash fire or a high heat incident, for example, exposure to an electrical arc flash is present, but of a low probability. In some embodiments, the laminates can have a weight of, for example, less than or equal to 500 grams per meter² (gsm). In some embodiments, the laminates can have a weight of in the range of from 200 gsm to 500 gsm, or from 200 gsm to 475 gsm, or from 200 gsm to 450 gsm or from 200 gsm to 425 gsm, or from 200 gsm to 400 gsm. In still further embodiments, the laminate can have a weight in the range of from 225 gsm to 400 gsm, or from 250 gsm to 375 gsm, or from 275 gsm to 375 gsm, or from 275 gsm to 350 gsm.

To reduce the weight of the laminates, the weight has to be reduced without losing the protective properties or decreasing breathability or waterproofness. As described herein, the weight of each of the first textile layer, the carrier layer and the second textile layer can be reduced without sacrificing the ability of the laminate to provide the wearer with protection from a high heat incident or electric arc flash exposure. By utilizing relatively lightweight layers, the overall weight of the laminates can be reduced. However, when the weight of the layers a), c) and/or e) is too low, there can be an increased risk during a flash fire or other high heat condition that enough heat or energy from the incident can affect the wearer. Therefore, the present laminates provide additional protection by utilizing at least two layers of heat reactive material. The first layer of heat reactive material absorbs at least a portion of the heat from the incident, while the second layer of heat reactive material can absorb an additional amount of heat that may have been transferred through the carrier layer and can help to minimize the heat transferred to a wearer.

### First Textile Layer

Laminates described herein comprise a first textile layer. Suitable fibers, filaments or yarns for the first textile layer can comprise nylon, nylon 6, nylon 6.6, nylon 12, nylon 6.12, polyester, polyethylene terephthalate, polytrimethylene terephthalate, polybutylene terephthalate, polyurethane, elastane, acrylic, polyolefin, polyethylene, polypropylene, aramids, meta-aramids, para-aramids, NOMEX® aramid, KEVLAR® aramid, polyamide-imides, polybenzimidazole (PBI), polybenzoxazole (PBO), FR viscose, FR cotton, modacrylic, polyamine, carbon fiber, fiberglass, polyacrylonitrile (PAN), PTFE, viscose, rayon, cotton, wool, silk, cellulose, jute, flax, bamboo, hemp or a combination thereof. The fibers and/or filaments can be combined using known methods to form yarns. A yarn can be produced from a single type of fiber or filament, or the yarn may be produced from a blend of two or more different types of fibers or filaments. Similarly, the first textile layer may be formed from a single type of fibers, filaments, and/or yarns or from multiple different fibers, filaments and/or yarns to provide the desired textile properties. The textiles can be woven, knits or nonwoven textiles.

The first textile layer forms a portion of the laminate that is intended to be an outer layer of the article, exposed directly to a high energy event, for example, exposure to heat and/or flame. In some embodiments, the first textile layer comprises a meltable textile layer, i.e., a textile layer that comprises meltable fibers according to the definition of meltable as provided herein. In some embodiments, the first textile layer comprises a nonmeltable textile layer, for example, a cotton textile. In other embodiments, the first textile layer can comprise a combination of meltable and nonmeltable fibers, filaments and/or yarns, for example, a nylon/cotton blend or a polyester/cotton blend. In some embodiments, the first textile is a textile that is a no melt and/or no drip textile according to the melting and thermal stability test as defined herein. In some embodiments, the first textile is a textile that comprises meltable fibers, filaments or yarns and considered to be a no melt and/or no drip textile according to the melting and thermal stability test as defined herein.

In still further embodiments, the laminate comprises a first textile comprising a combination of meltable and nonmeltable fibers in the range of from 1 to 99% nonmeltable fibers and from 1 to 99% meltable fibers. In other embodiments, the first textile layer can comprise in the range of from 5% to 100% meltable fibers, or from 10% to 100% meltable fibers, or from 20% to 100% meltable fibers, or from 25% to 100% meltable fibers, or from 30% to 100% meltable fibers, or from 35% to 100% meltable fibers, or from 40% to 100% meltable fibers, or from 50% to 100% meltable fibers, or from 60% to 100% meltable fibers, or from 70% to 100% meltable fibers, or from 80% to 100% meltable fibers, or from 90% to 100% meltable fibers. Each of the percentages are based on the total weight of the meltable and nonmeltable fibers in the first textile layer. In further embodiments, the first textile layer can be a knit, e.g., a nylon knit, a polyester knit, a polyurethane knit or knits containing combinations of one or more nylons, polyesters, cotton, and/or polyurethanes. A knit construction may provide a relatively lightweight textile that helps to reduce the overall weight of the laminate while still retaining the desired flame resistant and/or arc resistant properties of the laminate. In some embodiments, the laminate comprises a first textile layer that is free from or essentially free from flame retardant or flame resistant additives. In some embodiments, the first textile layer may be produced from one or more recycled fibers, filaments or textiles.

In some embodiments, the first textile layer comprises a textile produced from fibers, filaments or yarns having a denier (weight in grams of 9,000 meters of the fiber, filament or yarn) in the range of from 5 denier (D) to 400 D. In other embodiments, the fibers, filaments or yarns can have a weight in the range of from 5 D to 300 D or from 5 D to 250 D or from 5 D to 200 D or from 7 D to 150 D or from 7 D to 100 D. In some embodiments, the first textile layer can be a woven or a knit textile comprising nylon fibers, filaments or yarns with a denier weight of in the range of from 5 D to 400 D. In some embodiments the first textile layer comprises a woven or knit textile made from nylon yarns, wherein the yarns are in the range of from 5 D to 400 D or from 5 D to 300 D or from 5 D to 250 D or from 5 D to 200 D or from 7 D to 150 D or from 7 D to 100 D. In other embodiments, the first textile layer can be a woven or a knit textile made from polyester fibers, filaments or yarns, wherein the yarns are in the range of from 5 D to 400 D or from 5 D to 300 D or from 5 D to 250 D or from 5 D to 200 D or from 7 D to 150 D or from 7 D to 100 D. Optionally, any of the first textile layers described herein can be waterproof and/or the first textile layer can be water resistant by coating with a layer of a durable water resistant (DWR) coating. This DWR coating can be on the outer side of the first textile layer, on the side that is opposite the first layer of heat reactive material. In another embodiment, the first textile layer comprises a waterproof material.

The first textile layer may also comprise antistatic agents, antistatic particles, antistatic fibers, or antistatic polymers as a filler, as a coating, or as part of the fibers that make up the first textile layer. Suitable antistatic materials can comprise, for example, carbon black, conductive fibers, metal particles, or electrically conductive polymers.

The first textile layer is lightweight, having a weight less than or equal to 200 grams/square meter (gsm), e.g., less than 200 gsm, less than 190 gsm, less than 180 gsm, less than 170 gsm, less than 160 gsm, less than 150 gsm, less than 140 gsm, less than 130 gsm, less than 125 gsm, less than 120 gsm, less than 110 gsm, less than 100 gsm, less than 90 gsm or less than 85 gsm. In order for the first textile layer to have sufficient strength and durability, the textile weight should be greater than or equal to 15 gsm, or greater than or equal to 20 gsm, or greater than or equal to 25 gsm, or greater than or equal to 30 gsm, or greater than or equal to 35 gsm, or greater than or equal to 40 gsm, or greater than or equal to 45 gsm, or greater than or equal to 20 gsm, or greater than or equal to 55 gsm. It should be noted that with increasing amounts of nonmeltable fibers, the weight of the textile generally needs to be higher in order to have a first textile layer with adequate durability, strength, and abrasion-resistance. For example, with a 50/50 nylon/cotton blend, the textile weight should be in the range of 120 to about 150 gsm.

### Heat Reactive Material

Laminates described herein also comprise a first layer of heat reactive material and a second layer of heat reactive material. The first and second layers of heat reactive material can be chosen independently of each other and can be the same or different. For the purpose of this disclosure, the following description of the heat reactive material is intended to describe materials that can be used for the first and/or the second layers of heat reactive materials, unless otherwise specifically noted.

Laminates described herein comprise at least two layers of heat reactive material. Each layer of the heat reactive material independently comprises a mixture of a polymer resin and a graphite, for example, an expandable graphite. An expandable graphite that is suitable for use in the laminates and methods disclosed herein has an average expansion rate of at least 9 micrometer/° C. (μm/° C.) between 180° C. and 280° C. Depending on the desired properties of the laminate, it may be desirable to use an expandable graphite having an expansion rate greater than 9 μm/° C. between 180° C. and 280° C., or an expansion rate greater than 12 μm/° C. between 180° C. and 280° C., or an expansion rate greater than 15 μm/° C. between 180° C. and 280° C. One expandable graphite suitable for use in certain embodiments expands by at least 900 micrometers (μm) in a thermo-mechanical analysis (TMA) expansion test described herein when heated to 280° C. Another expandable graphite suitable for use in certain embodiments expands by at least 400 μm in TMA expansion test described herein when heated to 240° C.

Another expandable graphite suitable for use in certain embodiments expands by at least 400 μm in the TMA expansion test described herein when heated to 240° C. If tested using the Furnace Expansion Test described herein, expandable graphite suitable for use in the articles have an average expansion of at least 9 cc/g at 300° C. In one example, Asbury 3626 expandable graphite (available from Asbury Graphite Mills, Inc) has an average expansion of about 19 cc/g at 300° C., whereas Asbury 3538 expandable graphite (available from Asbury Graphite Mills. Inc.) has an expansion of only about 4 cc/g at 300° C., when tested according to the Furnace Expansion Test as described herein.

In one embodiment the heat reactive materials are in the form of a mixture of a polymer resin and an expandable graphite. Expandable graphite particle size suitable for present invention should be chosen so that the heat reactive material may be applied with the selected application method. For example, where the heat reactive material is applied by a gravure printing technique, the expandable graphite particle size should be small enough to fit in the gravure cells.

In certain embodiments, the heat reactive materials comprise expandable graphite having at least the expansion as described above and an endotherm of at least about 100 Joules/gram (J/g) when tested according to the DSC Endotherm Test method described herein. In other embodiments, it may be desirable to use expandable graphite with an endotherm greater than or equal to about 150 J/g greater than or equal to about 200 J/g or an endotherm greater than or equal to about 250 J/g.

In some embodiments, laminates comprising heat reactive material with expandable graphite having an expansion greater than 900 micrometers (μm) at 280° C. and an endotherm greater than 100 J/g, have an average afterflame value of less than 20 seconds, an average char length of less than 20 centimeters (cm) or both and an afterflame value of less than 20 seconds and an average char length of less than 20 cm, when tested according to the Edge Ignition Test described herein.

In other embodiments, the laminates can have an average afterflame of less than 10 seconds, or less than 2 seconds and/or the laminates may have an average char length less than 15 cm or less than 10 cm, when tested according to the Edge Ignition Test.

The first and second layer of heat reactive material each independently comprise a polymer resin and expandable graphite. Polymer resins having a melt or softening temperature of less than 280° C. are suitable for use in the heat reactive material. In some embodiments, the polymer resins are sufficiently flowable or deformable to allow the expandable graphite to expand substantially upon heat exposure at or below 280° C. It may be desirable that the extensional viscosity of a polymer resin is low enough to allow for the expansion of expandable graphite and high enough to maintain the structural integrity of the heat reactive material after expansion of the mixture of polymer resin and expandable graphite. In other embodiments, a polymer resin is used which has a storage modulus between 10³ and 10⁸ dyne/cm² and Tan delta between 0.1 and 10 at 200° C. In other embodiments, the polymer resin has a storage modulus between 10³ and 10⁶ dyne/cm². In another embodiment, a polymer resin is used that has a storage modulus between 10³ and 10⁴ dyne/cm². Polymer resins suitable for use in some embodiments are elastomeric. Other polymer resins suitable for use in some embodiments are cross-linkable, such as cross-linkable polyurethane, for example, MOR-MELT® R7001E (from Rohm & Haas). In other embodiments, suitable polymer resins are thermoplastic having a melt temperature between 50° C. and 250° C., such as DESMOMELTR VP KA 8702 (from Covestro AG, Leverkusen, DE). Polymer resins suitable for use in embodiments described herein comprise polymers which include but are not limited to polyesters, thermoplastic polyurethanes and cross-linkable polyurethanes, and combinations thereof. Other polymer resins may comprise one or more polymers selected from polyester, polyamide, acrylic, vinyl polymer, polyolefin, silicone or epoxy.

The heat reactive material may comprise a flame retardant material. In some embodiments, the flame retardant materials may be optionally incorporated in the polymer resin. In some embodiments, the polymer resins may include at least one component or additive selected from the group consisting of chlorinated compounds, brominated compounds, antimony oxide, organic phosphorous-based compounds, phosphate esters, resorcinol bis(diphenyl phosphate), zinc borate, ammonium polyphosphate, melamine cyanurate, melamine polyphosphate, molybdenum compounds, alumina trihydrate and magnesium hydroxide, which may enhance the flame resistance of the composite articles. In some embodiments, the flame retardant materials are melamine polyphosphate, resorcinol bis(diphenyl phosphate), or a combination thereof. The flame retardant materials may be present in an amount in the range of from 0% to 60% by weight, based on the total weight of the heat reactive material. In other embodiments, the flame retardant materials may be present in an amount in the range of from 10% to 55% by weight, based on the total weight of the heat reactive material. In some embodiments, at least one of the first layer or the second layer of heat reactive material comprises a flame retardant material.

In some embodiments, upon exposure of the laminate to flames and/or extreme heat, for example, at a temperature greater than or equal to 280° C., a meltable portion of the first textile layer, if present, absorbs into the heat reactive material. At the same time, the heat reactive material can expand. In other embodiments, upon exposure of the laminate to flames and/or extreme heat, for example, at a temperature greater than or equal to 300° C., a meltable portion of the first textile layer, if present, absorbs into the heat reactive material. At the same time, the heat reactive material can expand. These processes can also form a char comprised of the first textile layer and the heat reactive material.

The char resulting from exposure of the first textile layer and the first layer of heat reactive material to heat and/or high temperatures, for example, greater than or equal to 280° C. or greater than or equal to 300° C. is a heterogeneous melt mixture of the first textile layer and the expanded first layer of heat reactive material. A char, according to this disclosure, is meant to refer to the carbonaceous material remaining after exposing the melt of a layer and the heat reactive material to a temperature of greater than or equal to 280° C. or greater than or equal to 300° C. The char is a mixture of the expanded graphite and one or both of the melted polymer resin and any meltable portion of the first textile layer. At temperatures greater than or equal to 280° C. or greater than or equal to 300° C., one or both of the first textile layer and polymer resin may also oxidize or participate in the combustion process forming additional carbonaceous material that becomes part of the char. The formation of the char can help to insulate the layers behind the char from exposure to heat.

Upon exposure of the laminate to flames and/or extreme heat, the first layer of heat reactive material can expand within (or mix with) the melt of the first textile layer. In doing so the first layer of heat reactive material mixes with the melted first textile layer and protects the layers beneath and the wearer of the article. In one embodiment, laminates can have a break-open time that is increased by at least 20 seconds, or increased by at least 30 seconds, over a laminate constructed of substantially the same materials, but without the expandable graphite material, in which the expansion process described above does not occur, when tested according to the method for Horizontal Flame Test described herein.

In some embodiments of the heat reactive material, the mixture, upon expansion, forms a plurality of tendrils comprising expanded graphite. The total surface area of the heat reactive material increases significantly when compared to the same mixture prior to expansion. In one embodiment, the surface area of the mixture is increased at least five times after expansion. In another embodiment, the surface area of the mixture increases at least ten times after expansion. In addition, tendrils will often extend outward from the expanded mixture. In an embodiment where the heat reactive material is situated on a substrate in a discontinuous form, the tendrils will extend to at least partially fill the open areas between the discontinuous domains. In a further embodiment, the tendrils will be elongated, having a length to width aspect ratio of at least 5 to 1.

During exposure to a high energy event, for example, exposure to heat, flame and/or an arc flash, the combination of the first textile layer and the first layer of heat reactive material may dissipate or absorb at least a portion of the incident energy being transferred during the high energy event, due to the melting and/or expansion described above. If the energy and/or heat transferred through the carrier layer is high enough, the expandable graphite particles of the second layer of heat reactive material can expand in the same manner as the expandable graphite in the first layer of heat reactive material, forming an additional layer of insulation and absorbing another portion of the energy from the high energy event, thereby providing an increased level of thermal protection to the wearer. In some embodiments, the second textile layer may comprise meltable fibers, filaments and/or yarns. If the second textile layer also melts, the second layer of heat reactive material can absorb the melting second textile layer to minimize injury to a wearer.

In one embodiment the heat reactive material may be produced by a method that provides an intimate blend of polymer resin and expandable graphite, without causing substantial expansion of the expandable graphite. Suitable mixing methods include but are not limited to paddle mixer, blending and other low shear mixing techniques. In one method, the intimate blend of polymer resin and expandable graphite particles is achieved by mixing the expandable graphite with a monomer or prepolymer prior to polymerization of the polymer resin. In another method, the expandable graphite may be blended with a dissolved polymer, wherein the solvent in removed after mixing. In another method, expandable graphite is blended with a hot melt polymer at a temperature below the expansion temperature of the expandable graphite and above the melting temperature of the polymer. In methods which provide an intimate blend of polymer resin and expandable graphite particles or agglomerates of expandable graphite, the expandable graphite is coated or encapsulated by the polymer resin prior to expansion of the expandable graphite. In other embodiments, the intimate blend is achieved prior applying the heat reactive material to a substrate.

The heat reactive material comprises less than or equal to 50 weight percent (wt %), or less than or equal to 40 wt %, or less than or equal to 30 wt % of the expandable graphite based on the total weight of the heat reactive material, and the balance substantially comprising the polymer resin and flame retardant materials. In other embodiments, the expandable graphite comprises less than or equal to 20 wt %, or less than or equal to 10 wt %, or less than or equal to 5 wt % of the heat reactive material, and the balance substantially comprising the polymer resin and flame retardant materials. Generally, from 5 wt % to 50 wt % of expandable graphite based on the total weight of the heat reactive material, is desired. In some embodiments, desirable flame resistance performance may be achieved with even lower amounts of expandable graphite. Loadings as low as 1 wt % may be useful. Depending on the properties desired and the construction of the resulting laminates, other levels of expandable graphite may also be suitable for other embodiments. Other additives such as pigments, fillers, antimicrobials, processing aids and stabilizers may also be added to the heat reactive material. If present, the other additives are generally present in amounts of less than about 10% by weight, based on the total weight of the heat reactive material.

The first and second layers of heat reactive material and, more particularly, the polymer resin may function as an adhesive, for example, for attaching or bonding one layer to an adjacent layer. For example, the first layer of heat reactive material may adhere the first textile layer to the carrier layer and the second layer of heat reactive material may adhere the carrier layer to the second textile layer. The first and second layers of heat reactive material may independently be in the form of a discontinuous adhesive, for example, a series of individual dots or shapes that do not touch or overlap one another. In other embodiments, the first and/or the second layers of heat reactive material may be a continuous layer extending across a majority of the length and/or the width of the laminate. In still further embodiments, the first and/or the second layers of heat reactive material may be in the form of a series of lines or grids extending across a majority of the length and/or width of the laminate. The lines or grids may be straight, curved, may be essentially parallel to each other, and/or they may overlap one another. When the first and/or second layers of heat reactive material are applied in a discrete discontinuous manner, the shape of the dot of the heat reactive material may take essentially any form. In some embodiments, the shape may be a circle, an oval, a triangle, a square, a rectangle, a star, a polygon, a four-sided polygon or any other discrete shape. The shape of the first layer of heat reactive material may be chosen independently of that of the shape of the second layer of heat reactive material.

An amount of the heat reactive material should be applied to adhere each of the first textile layer, the carrier layer and the second textile layer of the laminate and to provide the desired protection from a high energy event. Typically, each of the first and second layers of heat reactive materials are applied so as to provide at least 20 grams per meter² (gsm) of the heat reactive material. In some embodiments, the amount of each of the first and second layer of heat reactive material can independently be in the range of from 20 gsm to about 130 gsm. In other embodiments, the amount of each of the first and second layer of heat reactive material can independently be in the range of from 30 gsm to 120 gsm, or from 40 gsm to 110 gsm, or from 50 gsm to 110 gsm, or from 60 gsm to 110 gsm, or from 70 gsm to 110 gsm.

### Carrier Layer

The laminate comprises a carrier layer that is located between the first and second layers of heat reactive material. The carrier layer can provide the laminate with strength and durability, both before an exposure to a high energy event that causes expansion of one or more layers of the heat reactive material and after such an exposure. The carrier layer can be a film or a textile or a carrier composite layer comprising at least a film and a textile. As used herein, the term “film” means a continuous substrate having a length and a width that is much greater than its thickness. Films can be monolithic (i.e., nonporous), microporous, or have regions that are monolithic and regions that are microporous. In some embodiments, the carrier layer can be a microporous film that has the pores filled or at least partially filled with one or more of a particulate filler and/or a polymer. A microporous film can be a substrate that has a node and fibril structure. It should be noted that a microporous film having a node and fibril structure is considered to be different from a textile. In some embodiments, the carrier layer is free from or essentially free from flame retardant or flame resistant additives. In other embodiments, the carrier layer can be a microporous film that is at least partially filled with a polymer, wherein the polymer filing at least a portion of the pores comprises a flame retardant additive.

In some embodiments, the carrier layer comprises at least one convective barrier film. Convective barrier films can comprise, for example, heat stable films such as fluoropolymer, polyimide, silicone, polyurethane, polytetrafluoroethylene (PTFE), expanded PTFE (ePTFE) or a combination thereof.

In some embodiments, the carrier layer comprises a waterproof, breathable and air-impermeable film; an air-impermeable film; an air-permeable film; or a film that is waterproof, breathable and air-permeable. As an example of a waterproof, breathable and air-impermeable film, the carrier layer can comprise a 3-layer film comprising two layers of ePTFE bonded together with a layer of polyurethane or flame retardant polyurethane, such as taught in U.S. Pat. No. 9,782,947 to Gunzel, et al, which is incorporated herein in its entirety. As another embodiment of a waterproof and breathable film, the carrier layer can comprise an expanded fluoropolymer substrate, for example, an expanded polytetrafluoroethylene substrate comprising a node and fibril structure, wherein the pores are filled or at least partially filled with a polymer, for example, polyurethane or flame retardant polyurethane. In some embodiments, the carrier layer is a waterproof, breathable and air-permeable carrier film comprising an expanded fluoropolymer or an expanded PTFE film and having two or more layered regions, wherein each region has a different microstructure. For example, a first layer can have a microstructure having a relatively larger average pore size and a relatively smaller node size compared to a second layer having a microstructure with a relatively smaller average pore size and correspondingly, a relatively larger average node size. In some embodiments, the carrier layer comprises a waterproof, breathable and air-permeable carrier film can have three different microstructure regions, for example, the outer two layers can have relatively larger pore sizes and the middle layer can have relatively smaller pore sizes compared to the outer microstructure layers. Suitable barrier films having two or more different microstructure layers are taught in U.S. Pat. No. 9,440,044 to Hodgins, et al, which is incorporated herein in its entirety. In some embodiments, the carrier layer comprises an air-permeable carrier film, for example, a microporous fluoropolymer or a microporous ePTFE film. In other embodiments of an air permeable carrier film, the carrier layer comprises a microporous fluoropolymer or a microporous ePTFE film that is free from or essentially free from any polymers filling the pores. In still other embodiments, any of the above expanded or microporous carrier layers may comprise a coating of a fluoropolymer on the pore walls, that is, on the nodes and fibrils of a microporous film.

When the laminates are used for garments, the carrier layer comprising a thermally stable convective barrier can help to minimize the convective heat transfer from an outer layer, i.e., the first textile layer, to the layers that are closer to the wearer, i.e., the second textile layer, when exposed to a high energy event. Film-based convective barrier layers described herein can have a maximum air permeability of less than about 10 Frazier (liters/meter²/second (l/m²/s)) after thermal exposure when tested as per the Air Permeability test described herein. Preferably, a film-based convective barrier layer has an air permeability after thermal exposure of less than 5 Frazier. More preferably, a film-based convective barrier layer has an air permeability after thermal exposure of less than 3 Frazier.

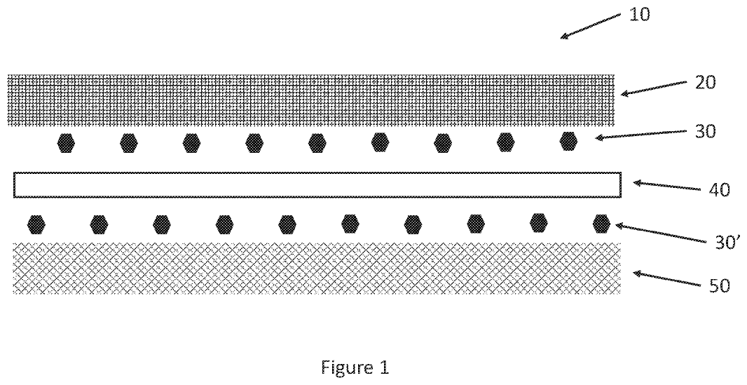

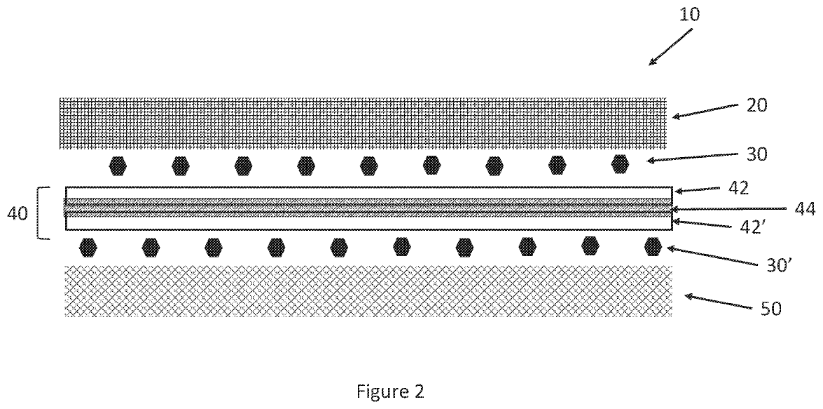

In some embodiments, as exemplified by FIG. 1, the laminate (10) comprises a first textile layer (20), two layers of heat reactive material (30) and (30′), a carrier layer (40), and a second textile layer (50). In a further embodiment, as exemplified in FIG. 2, the laminate (10) may comprise a first textile layer (20), a carrier layer (40) that may be a multilayer thermally stable barrier, two layers of heat reactive material (30) and (30′), and a second textile layer (50). The carrier layer (40) comprises two thermally stable expanded microporous films (42) and (42′) and a polymer layer (44) therebetween. The polymer layer (44) is shown extending at least partially into the pores of the expanded microporous films (42) and (42′). The polymer layer (44) may be waterproof or air impermeable or both. The polymer layer (44) may be a polyurethane or a layer of polyurethane that contains one or more flame retardant agents.

The carrier layer may also comprise a textile-based carrier layer or a textile carrier layer. Suitable fibers, filaments or yarns for use in the textile-based carrier layer can comprise nylon, nylon 6, nylon 6.6, nylon 12, nylon 6.12, polyester, polyethylene terephthalate, polytrimethylene terephthalate, polybutylene terephthalate, polyurethane, elastane, acrylic, polyolefin, polyethylene, polypropylene, aramids, meta-aramids, para-aramids, NOMEX® aramid, KEVLAR® aramid, polyamide-imides, polybenzimidazole (PBI), polybenzoxazole (PBO), FR viscose, FR cotton, modacrylic, polyamine, carbon fiber, fiberglass, polyacrylonitrile (PAN), PTFE, viscose, rayon, cotton, wool, silk, cellulose, jute, flax, bamboo, hemp or a combination thereof. The fibers and/or filaments can be combined using known methods to form yarns. A yarn can be produced from a single type of fiber or filament, or the yarn may be produced from a blend of two or more different types of fibers or filaments. Similarly, the textile-based carrier layer may be formed from a single type of fibers, filaments, and/or yarns or from multiple different fibers, filaments and/or yarns to provide the desired textile properties. The textile-based carrier layers can be woven, knits or nonwoven textiles.

In some embodiments, the textile-based carrier layer can comprise a combination of one or more meltable fibers and one or more nonmeltable fibers. In some embodiments, the textile-based carrier layer can be a nylon/cotton blend or a polyester/cotton blend. In some embodiments, the textile-based carrier layer can be a woven rip-stop textile produced with a meltable yarn, for example, a nylon or a polyester, and a flame-resistant yarn as the rip-stop yarn placed at every 5 to 30 warps and/or wefts, for example, an aramid yarn. In still further embodiments, the textile-based carrier layer can be a textile comprising a combination of meltable fibers, filaments or yarns and abrasion-, heat- and flame-resistant (FR) fibers, filaments, or yarns. In some embodiments, the textile-based carrier layer can be a textile comprising nonmeltable fibers, for example, aramids, polybenzimidazole (PBI), polybenzoxazole (PBO), FR viscose, FR cotton, modacrylic, polyamine, carbon fiber, fiberglass, polyacrylonitrile (PAN), PTFE or a combination thereof. In some embodiments, the textile-based carrier layer can be a nonwoven textile made from an aramid. In other embodiments, the textile-based carrier layer can be a nonwoven textile make from a meta-aramid.

The carrier layer may have a weight in the range of from 3 grams per meter² (gsm) to 100 gsm. In other embodiments, the carrier layer can have a weight in the range of from 4 gsm to 90 gsm, or from 4 gsm to 80 gsm, or from 4 gsm to 75 gsm, or from 4 gsm to 70 gsm, or from 4 gsm to 65 gsm, or from 4 gsm to 60 gsm, or from 4 gsm to 58 gsm, or from 4 gsm to 56 gsm, or from 4 gsm to 55 gsm, or from 4 gsm to 50 gsm.

The carrier layer may also comprise antistatic agents, antistatic particles, antistatic polymers, or antistatic fibers as a filler or as a coating. Suitable antistatic agents, particles or polymers can comprise, for example, carbon black, conductive fibers, metal particles, or electrically conductive polymers.

### Second Textile Layer

The laminate further comprises a second textile layer that is adjacent to the second layer of heat reactive material on the opposite side from that of the carrier layer. The second textile layer forms one of the outer layers of the laminate and is on the opposite side of the first textile layer. Therefore, the laminate has two ‘outer’ layers, the first textile layer and the second textile layer, with the two layers of heat reactive material and the carrier layer forming the ‘inner’ layers of the laminate. When the laminate is formed into an article, for example, a garment, the first textile layer is intended to be an outer layer of the garment and the second textile layer is intended to be an inner layer of the garment. However, because the laminate is a 3-layer laminate with adhesive layers connecting the 3-layers (first textile layer, carrier layer and second textile layer), in certain embodiments, the second textile layer may be used as an outer layer and the first textile layer may be an inner layer of the garment.

The second textile layer can be any single layer or multilayer textile that is commonly used in the textile industry. Suitable fibers, filaments or yarns can comprise nylon, nylon 6, nylon 6.6, nylon 12, nylon 6.12, polyester, polyethylene terephthalate, polytrimethylene terephthalate, polybutylene terephthalate, polyurethane, elastane, acrylic, polyolefin, polyethylene, polypropylene, aramids, meta-aramids, para-aramids, NOMEX® aramid, KEVLAR® aramid, polyamide-imides, polybenzimidazole (PBI), polybenzoxazole (PBO), FR viscose, FR cotton, modacrylic, polyamine, carbon fiber, fiberglass, polyacrylonitrile (PAN), PTFE, viscose, rayon, cotton, wool, silk, cellulose, jute, flax, bamboo, hemp or a combination thereof. The fibers and/or filaments can be combined using known methods to form yarns. A yarn can be produced from a single type of fiber or filament, or the yarn may be produced from a blend of two or more different types of fibers or filaments. Similarly, the second textile layer may be formed from a single type of fibers, filaments, and/or yarns or from multiple different fibers, filaments and/or yarns to provide the desired textile properties. The textiles can be woven, knits or nonwoven textiles. In some embodiments, the second textile layer is free from or essentially free from flame retardant or flame resistant additives.

In some embodiments, the second textile layer can be a flame retardant textile layer comprising one or more flame retardant natural fibers or flame retardant synthetic fibers or filaments. In some embodiments, the second textile layer can be a textile comprising in the range of from 45 to 90% polyester and from 10 to 55% cotton. In other embodiments, the second textile can be a textile comprising in the range of from 40% to 60% of a polyamide-imide, from 40 to 60% of viscose and 1 to 5% of an anti-static agent. In other embodiments, the second textile layer can be a textile comprising in the range of from 50 to 70% viscose and from 30 to 50% polyester. In other embodiments, the second textile can be a textile comprising a meta-aramid or a para-aramid, viscose and nylon. In other embodiments, the second textile layer can be a meltable textile layer. In some embodiments, the first textile layer and the second textile layer comprise meltable textile layers. In some embodiments, the second textile is a textile that is a no melt and/or no drip textile according to the melting and thermal stability test as defined herein. In some embodiments, the second textile is a textile that comprises meltable fibers, filaments or yarns and considered to be a no melt and/or no drip textile according to the melting and thermal stability test as defined herein.

In still further embodiments, the laminate comprises a second textile comprising a combination of meltable and nonmeltable fibers in the range of from 1 to 99% nonmeltable fibers and from 1 to 99% meltable fibers. In other embodiments, the second textile layer can comprise in the range of from 5% to 100% meltable fibers, or from 10% to 100% meltable fibers, or from 20% to 100% meltable fibers, or from 25% to 100% meltable fibers, or from 30% to 100% meltable fibers, or from 35% to 100% meltable fibers, or from 40% to 100% meltable fibers, or from 50% to 100% meltable fibers, or from 60% to 100% meltable fibers, or from 70% to 100% meltable fibers, or from 80% to 100% meltable fibers, or from 90% to 100% meltable fibers. Each of the percentages are based on the total weight of the fibers in the second textile layer. In further embodiments, the second textile layer can be a knit, e.g., a nylon knit, a polyester knit, a polyurethane knit or knits containing combinations of one or more nylons, polyesters and/or polyurethanes. A knit construction may provide a relatively lightweight textile that helps to reduce the overall weight of the laminate while still retaining the desired flame resistant and/or arc resistant properties of the laminate. In some embodiments, the laminate comprises a second textile layer that is free from or essentially free from flame retardant or flame resistant additives. In some embodiments, the second textile layer may be produced from one or more recycled fibers, filaments or textiles.

The second textile layer may also comprise antistatic agents, antistatic particles, antistatic polymers, or antistatic fibers as a filler or as a coating. Suitable antistatic agents, particles or polymers can comprise, for example, carbon black, conductive fibers, metal particles, or electrically conductive polymers. In some embodiments, the second textile layer can comprise meltable fibers and one or more antistatic agents.

The second textile layer can be a woven, knit or a nonwoven textile. In some embodiments, the second textile is a relatively lightweight textile produced from one or more synthetic fibers, for example, a knit comprising a blend of cotton and polyester. In another embodiments, the second textile layer can be an inherently flame retardant layer comprising flame retardant fibers or filaments. In one embodiment, the second textile layer can be a woven textile comprising a blend of aramid, flame retardant viscose and an anti-static additive. The second textile layer is lightweight, having a weight less than or equal to 200 grams/square meter (gsm), e.g., less than 200 gsm, less than 190 gsm, less than 180 gsm, less than 170 gsm, less than 160 gsm, less than 150 gsm, less than 140 gsm, less than 130 gsm, less than 125 gsm, less than 120 gsm, less than 110 gsm, less than 100 gsm, less than 90 gsm or less than 85 gsm. In order for the second textile layer to have sufficient strength and durability, the textile weight should be greater than or equal to 15 gsm, or greater than or equal to 20 gsm, or greater than or equal to 25 gsm, or greater than or equal to 30 gsm, or greater than or equal to 35 gsm, or greater than or equal to 40 gsm, or greater than or equal to 45 gsm, or greater than or equal to 20 gsm, or greater than or equal to 55 gsm. It should be noted that with increasing amounts of nonmeltable fibers, the weight of the textile generally needs to be higher in order to have a second textile layer with adequate durability, strength, and abrasion-resistance. For example, with a 50/50 nylon/cotton blend, the textile weight should be in the range of 120 to about 150 gsm.

### Additional Layers

One or more additional layers can be adhered to the laminates, wherein the additional layers are adhered to the first textile layer, to the second textile layer, or both. If the one or more additional layers are adhered to the first textile layer, then the one or more additional layers are chosen from the list of materials that are described as useful for the first textile layer. If the one or more additional layers are adhered to the second textile layer, then the one or more additional layers can be chosen from the list of materials that are described as useful for the second textile layer. The one or more additional layers can be adhered to the laminate using a known lamination adhesive, using one or more additional layers of the heat reactive material described herein or by any other conventional technique, for example, stitching, quilting, gluing, hook and loop fasteners, buttons, snaps or a combination thereof.

### Application of First and Second Layers of HRM

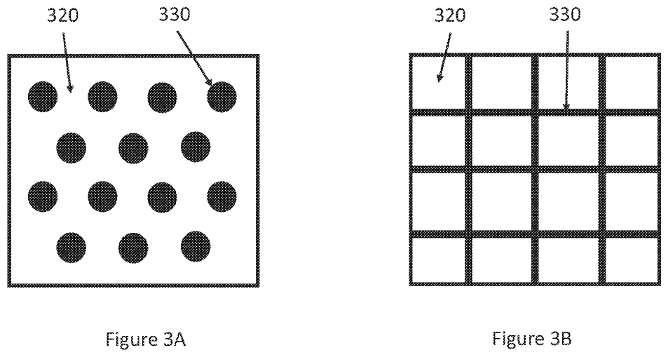

The first layer of heat reactive material may be applied to the carrier layer, to the first textile layer or to both. The second layer of heat reactive material can be applied to the carrier layer (on a side opposite the first layer of heat reactive material), to the second textile layer or to both. In some embodiments, the first and/or second layer of heat reactive material may be applied as a continuous layer. However, in embodiments where breathability and/or hand is desired, the first and/or second layer of heat reactive material may be applied discontinuously to form a layer of heat reactive material having less than 100% surface coverage. A discontinuous application providing less than 100% surface coverage may take a variety of forms including, but not limited to, dots, grids, lines or a combination thereof. In some embodiments with discontinuous coverage, the average distance between adjacent areas of the discontinuous pattern is less than 5 millimeters (mm), or preferably less than 3.5 mm, 2.5 mm, 1.5 mm, or 0.5 mm. The average distance between adjacent areas can be measured by measuring the edge-to-edge spacing between adjacent dots. In embodiments where properties such as hand, breathability, and/or laminate weight are important, a surface coverage of less than 90%, or less than 80%, or less than 70%, or less than 60%, or less than 50%, or less than 40%, or less than 30% may be used. In some embodiments, the first layer of heat reactive material covers greater than or equal to 25% of a surface of the first textile layer. In some embodiments, the second layer of heat reactive material covers greater than or equal to 25% of a surface of the second textile layer. The percent coverage may be calculated by measuring the geometry of the gravure cell or screen printing masks, depending on which application method is used. One method for achieving a coverage of less than 100% comprises applying the heat reactive material by printing the heat reactive material onto a surface of the first textile layer or a surface of the carrier layer by, for example, gravure printing. FIGS. 3A and 3B illustrate examples in which the layer of heat reactive material (330) is provided in discontinuous patterns of dots (FIG. 3A) and grids (FIG. 3B) to a layer, for example, the first textile layer (320). Each individual layer of the heat reactive material may be applied at a rate to achieve an add-on weight of between 20 gsm to 120 gsm of the heat reactive material. In some embodiments, a layer of the heat reactive material can be applied at a rate to achieve an add-on weight of less than 120 gsm, or less than 100 gsm, or less than 90 gsm, or less than 80 gsm. The add-on weight can be determined by weighing identical sized samples of the layer before and after the heat reactive material is applied and normalizing the size of the sample to one square meter.

In some embodiments, the process of forming a laminate comprising the first textile layer, the carrier layer, the second textile layer and the two layers of heat reactive material may be accomplished in a step-wise process, while in other embodiments, in a continuous process. In some embodiments, a step-wise process may include the step of forming a precursor laminate comprising the second textile layer, the carrier layer and the second layer of heat reactive material adhering the second textile layer and carrier layer together. In this step-wise process, a layer of the second heat reactive material may be applied in a continuous or a discontinuous manner to the second textile layer, to the carrier layer or to both the second textile layer and the carrier layer. The second textile layer and the carrier layer can then be adhered using any of the known lamination techniques, for example, using calender rolls to form a precursor laminate. The precursor laminate can be used directly as it is or can be stored for several minutes to days or months until needed. Following the formation of the precursor laminate, the first textile layer can then be applied. In this step, the first layer of heat reactive material can be applied in a continuous or a discontinuous manner to the first textile layer to the carrier layer side of the precursor laminate or to both, followed by adhering the first textile layer to the precursor laminate (on the carrier layer side), for example, using two or more calender rolls.

In other embodiments, the process of forming a laminate comprising the first textile layer, the carrier layer, the second textile layer and the two layers of heat reactive material may be accomplished in a step-wise process, wherein the precursor laminate comprises the first textile layer, the first layer of heat reactive material and the carrier layer. In these embodiments, a layer of the first heat reactive material may be applied in a continuous or a discontinuous manner to the first textile layer, to the carrier layer or to both the first textile layer and the carrier layer. The first textile layer and the carrier layer can then be adhered using any of the known lamination techniques, for example, using calender rolls to form the precursor laminate. The precursor laminate can be used directly as it is or can be stored for several minutes to days or months until needed. Following the formation of the precursor laminate, the second textile layer can then be applied. In this step, the second layer of heat reactive material can be applied in a continuous or a discontinuous manner to the second textile layer to the carrier layer side of the precursor laminate or to both, followed by adhering the second textile layer to the precursor laminate (on the carrier layer side), for example, using calender rolls. The step-wise processes as described herein can be performed in one facility, or multiple facilities, optionally in different locations. For example, the precursor laminate may be formed in one facility and transported to a second facility to form the laminate.

In other embodiments, a continuous lamination process can be used, wherein the first layer of heat reactive material can be applied to the first textile layer, to the carrier layer, or to both, the second layer of heat reactive material can be applied to the second textile layer to the carrier layer or to both, and in one or more lamination steps, the layers are adhered together wherein the first textile layer and the second textile layer form the outermost layers of the laminate and the carrier layer forms an inner layer between the outermost layers. In some embodiments, the first and second layers of heat reactive material act as an adhesive, adhering the laminate layers together.

In some embodiments, a method for forming the laminate comprises i) adhering the first textile layer to the carrier layer with a layer of the first heat reactive material to form a precursor laminate; and ii) adhering the precursor laminate to the second textile layer with a layer of the second heat reactive material. In other embodiments, a method for forming the laminate comprises i) adhering the second textile layer to the carrier layer with a layer of the second heat reactive material to form a precursor laminate; and ii) adhering the precursor laminate to the first textile layer with a layer of the first heat reactive material.

The first and second layers of heat reactive material are separated from each other by the carrier layer. When the first and second layers of heat reactive material are in a discontinuous form, for example, in the form of a series or array of dots, then a dot of the first layer of heat reactive material applied to one side of the carrier layer may be fully aligned, partially aligned or may not be aligned at all with a corresponding dot of the second layer of heat reactive material applied to the opposite side of the carrier layer. As used herein, fully aligned means that less than or equal to 10% of the surface area of a dot of the first layer of the heat reactive material is out of alignment with the corresponding surface area of a dot of the second layer of heat reactive material. As used herein, dots of the first and second layer of heat reactive material are said to be unaligned when less than or equal to 10% of the surface area of a dot of the first layer of heat reactive material aligns with the surface area of a corresponding dot of the second layer of heat reactive material. The dots of first and second layers of heat reactive material are said to be partially aligned when greater than 10% to less than 90% of the surface area of a dot of the first layer of heat reactive material extends beyond the surface area of a corresponding dot of the second layer of heat reactive material.

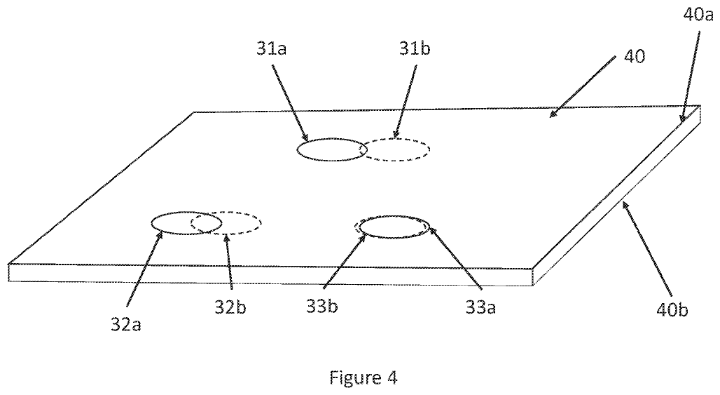

FIG. 4 shows illustrative examples of aligned, partially aligned, and unaligned dots of the heat reactive materials. FIG. 4 shows carrier layer (40) with dots of first layer of heat reactive material (31a), (32a) and (33a) on a first surface (40a) of the carrier layer (40) and dots of the second heat reactive material (31b), (32b) and (33b) shown on the second surface (40b) of the carrier layer (40). Heat reactive material (31b) is an example of an unaligned dot, when compared to the corresponding dot of the heat reactive material (31a). Heat reactive material (32b) is an example of a partially aligned dot, when compared with the corresponding dot of the heat reactive material (32a). Heat reactive material (33b) is an example of an aligned dot, when compared with the corresponding dot of heat reactive material (33a). While not wishing to be bound by theory, it is believed that the breathability and the moisture vapor transmission rate (MVTR) can be increased by increasing the alignment between the dots or lines of the first and second heat reactive materials.

In some embodiments, the first and second layers of heat reactive material are applied in a discontinuous manner having the form of a discrete shape, wherein at least a portion of the discrete shapes of the first layer of heat reactive material are at least partially aligned with a corresponding discrete shape of the second layer of heat reactive material. In other embodiments, the first and second layers of heat reactive material are applied in a discontinuous manner having the form of a discrete shape, wherein at least a portion of the discrete shapes of the first layer of heat reactive material are aligned with a corresponding discrete shape of the second layer of heat reactive material. In still further embodiments, the first and second layers of heat reactive material are applied in a discontinuous manner having the form of a discrete shape, wherein at least a portion of the discrete shapes of the first layer of heat reactive material are unaligned with a corresponding discrete shape of the second layer of heat reactive material. In still further embodiments, the first and second layers of heat reactive material are applied in a discontinuous manner having the form of a discrete shape, wherein the discrete shapes of the first layer of heat reactive material comprise a mixture of aligned, partially aligned and unaligned shapes when compared to the corresponding discrete shapes of the second layer of heat reactive material.

In some embodiments, the laminate has a weight of less than or equal to 500 grams/meter² (gsm). In other embodiments, the laminates have a weight of less than or equal to 450 gsm, or less than or equal to 425 gsm or less than or equal to 400 gsm, or less than or equal to 375 gsm, or less than or equal to 350 gsm, or less than or equal to 325 gsm.

The laminates described herein can provide a lightweight laminate that can provide protection against an electric arc as measured by IEC 61482-2 in the Electric Arc Box test (IEC 614821-2:2014) and/or the Open Arc Test (IEC 614821-1:2009, method A). In some embodiments, the laminates described herein complies with the standards IEC 614821-1:2014 and/or IEC 614821-2:2014 and has a weight of less than or equal to 500 gsm. In some embodiments, the laminates described herein complies with the standards IEC 614821-1:2014 and/or IEC 614821-2:2014 and has a weight of less than or equal to 475 gsm. In some embodiments, the laminates described herein complies with the standards IEC 614821-1:2014 and/or IEC 61482-1-2:2014 and has a weight of less than or equal to 450 gsm. In some embodiments, the laminates described herein complies with the standards IEC 614821-1:2014 and/or IEC 614821-2:2014 and has a weight of less than or equal to 425 gsm. In some embodiments, the laminates described herein complies with the standards IEC 61482-1-1:2014 and/or IEC 614821-2:2014 and has a weight of less than or equal to 400 gsm. In some embodiments, the laminates described herein complies with the standards IEC 614821-1:2014 and/or IEC 614821-2:2014 and has a weight of less than or equal to 375 gsm. In some embodiments, the laminates described herein complies with the standards IEC 614821-1:2014 and/or IEC 614821-2:2014 and has a weight of less than or equal to 350 gsm. In some embodiments, the laminates described herein complies with the standards IEC 614821-1:2014 and/or IEC 61482-1-2:2014 and has a weight of less than or equal to 325 gsm. In some embodiments, the laminates described herein complies with the standards IEC 614821-1:2014 and/or IEC 614821-2:2014 and has a weight of less than or equal to 300 gsm. In some embodiments, the laminates described herein complies with the standards IEC 61482-1-1:2014 and/or IEC 614821-2:2014 and has a weight of less than or equal to 275 gsm. In some embodiments, the laminates described herein complies with the standards IEC 614821-1:2014 and/or IEC 614821-2:2014 and has a weight of less than or equal to 265 gsm. In some embodiments, the laminates described herein complies with the standards IEC 614821-1:2014 and/or IEC 614821-2:2014 and has a weight of less than or equal to 250 gsm.

### Uses

Laminates as described herein can be useful to make protective articles. The protective articles can include, for example, garments such as shirts, jackets, pants, coveralls, overalls, aprons, hats, gloves and footwear; covers, blankets, tents and more. In each of these applications, the laminate should be oriented such that the meltable layer faces the potential threat. For example, wherein the laminate is used to form a jacket, the first textile layer should be oriented to face the outer portion of the jacket and the second textile layer is closer to a wearer so that in the event of exposure to a high energy or high temperature event, the first textile layer is exposed to the energy before the second textile layer.

### EXAMPLES

### Melting and Thermal Stability Test

The test was used to determine the thermal stability of textile materials. This test was based on thermal stability test as described in section 8.3 of NFPA 1975, 2004 Edition. The test oven was a hot air circulating oven as specified in ISO 17493. The test was conducted according to ASTM D 751, Standard Test Methods for Coated Fabrics, using the Procedures for Blocking Resistance at Elevated Temperatures (Sections 89 to 93), with the following modifications:

Borosilicate glass plates measuring 100 millimeters (mm)×100 mm×3 mm (4 inches (in)×4 in×⅛ in) were used; and

An internal oven test temperature of 280° C.±5° C. was used. The specimens were allowed to cool a minimum of 1 hour after removal of the glass plates from the oven.

Any sample side sticking to the glass plate, sticking to itself when unfolded or showing evidence of melting or dripping was considered as meltable. Any sample lacking evidence of melting was then retested (using a new sample of the material) at an internal oven test temperature of 300° C. After removal from the oven and cooling for 1 hour, any sample side sticking to the glass plate, sticking to itself when unfolded or showing evidence of melting or dripping was considered as meltable. Any sample not showing one of these melting criteria was considered to be a non-meltable sample and/or no-drip sample (e.g., was considered to be a non-meltable/no-drip textile).

TMA Expansion test:

TMA (Thermo-mechanical analysis) was used to measure the expansion of expandable graphite particles. Expansion was tested with TA Instruments TMA 2940 instrument. A ceramic (alumina) TGA pan, measuring roughly 8 mm in diameter and 12 mm in height was used for holding the sample. Using the macro-expansion probe, with a diameter of roughly 6 mm, the bottom of the pan was set to zero. Flakes of expandable graphite about 0.1-0.3 mm deep, as measured by the TMA probe, were put in the pan. The furnace was closed, and initial sample height was measured. The furnace was heated from about 25° C. to 600° C. at a ramp rate of 10° C./min. The TMA probe displacement was plotted against temperature; the displacement was used as a measure of expansion.

### DSC Endotherm Test:

Tests were run on a Q2000 DSC from TA Instruments using TZERO T™ hermetic pans. For each sample, about 3 milligrams (mg) of expandable graphite were placed in the pan. The pan was vented by pressing the corner of a razor blade into the center, creating a vent that was approximately 2 mm long and less than 1 mm wide. The DSC was equilibrated at 20° C. Samples were then heated from 20° C. to 400° C. at 10° C./min. Endotherm values were obtained from the DSC curves.

### Weight:

Weight measurements on materials were conducted as specified in ASTM D751, section 10. The units given are in grams per square meter.

Electric Arc Box Tests were performed using IEC 614821-2:2014.

The electric arc box test provides information about the performance of the material relative to the Stoll curve when subjected to an arc discharge, a result of “below” means that the material passes that portion of the test, while a result of “above” means that material failed the test. The box test also provides a measure of the burn time (pass <5 seconds, fail >5 seconds); hole formation (tested material passes this part of the test with no hole larger than 5 mm); and an overall pass/fail designation.

Open arc test was performed according to IEC 614821-1:2009, method A.

The data is provided as the Arc Thermal Performance Value and is provided in units of calories per square centimeter (cal/cm²).

### Furnace Expansion Test

A nickel crucible was heated in a hot furnace at 300° C. for 2 minutes. A measured sample (about 0.5 g) of expandable graphite was added to the crucible and placed in the hot furnace at 300° C. for 3 minutes. After the heating period, the crucible was removed from the furnace and allowed to cool and then the expanded graphite was transferred to a measuring cylinder to measure expanded volume. The expanded volume was divided by the initial weight of the sample to get expansion in cc/g units.

### Air Permeability Test:

To test the air permeability of a carrier film layer after thermal exposure, a 381 mm (15 in.) square specimen was clamped in a metal frame and then suspended in a forced air-circulating oven set to a temperature of 260° C. Following a 5-minute exposure, the specimen was removed from the oven. After allowing the specimen to cool down, the air permeability of the specimen was tested according to test methods entitled ISO 9237 (1995).

### Vertical Flame Test

Testing was performed in accordance with the ASTM D6413. Samples were exposed to flame for 12-seconds. After-flame time was averaged for 3 samples.

Laminates with after-flame of greater than 2 seconds were considered as flammable. Char length was also determined by this test. Samples were tested in both the warp and weft directions.

### Horizontal FLAME TEST

Procedure was followed according to ISO 15025 and the tests were performed on the face side and separately on the back side of the laminate. The test provided information on afterflame and the duration in seconds (if any); afterglow; hole formation; the presence of flaming debris; and the presence of flaming to the upper or vertical edge of the material.

### Moisture Vapor Transmission Rate (MVTR)

A description of the test employed to measure moisture vapor transmission rate (MVTR) is given below. The procedure has been found to be suitable for testing films, coatings, and coated products.

In the procedure, approximately 70 ml of a solution consisting of 35 parts by weight of potassium acetate and 15 parts by weight of distilled water are placed into a 133 ml polypropylene cup, having an inside diameter of 6.5 cm at its mouth. An expanded polytetrafluoroethylene (PTFE) membrane having a minimum MVTR of approximately 85,000 g/m²/24 hrs. as tested by the method described in U.S. Pat. No. 4,862,730 (to Crosby), is heat sealed to the lip of the cup to create a taut, leakproof, microporous barrier containing the solution.

A similar expanded PTFE membrane is mounted to the surface of a water bath. The water bath assembly is controlled at 23° C. plus 0.2° C., utilizing a temperature controlled room and a water circulating bath.

The sample to be tested is allowed to condition at a temperature of 23° C. and a relative humidity of 50% prior to performing the test procedure. Samples are placed so the microporous polymeric membrane is in contact with the expanded polytetrafluoroethylene membrane mounted to the surface of the water bath and allowed to equilibrate for at least 15 minutes prior to the introduction of the cup assembly.

The cup assembly is weighed to the nearest 1/1000g and placed in an inverted manner onto the center of the test sample.

Water transport is provided by the driving force between the water in the water bath and the saturated salt solution providing water flux by diffusion in that direction. The sample is tested for 15 minutes, and the cup assembly is then removed, weighed again within 1/1000g. The MVTR of the sample is calculated from the weight gain of the cup assembly and is expressed in grams of water per square meter of sample surface area per 24 hours.

### Edge Ignition Test

The edge ignition test was performed according to ISO 11612. This test provided information on afterflame and the duration in seconds (if any); afterglow; hole formation; the presence of flaming debris; and the presence of flaming to the upper or vertical edge of the material.

### Heat Reactive Material 1

A flame retardant polyurethane resin was prepared by first forming a resin in accordance with the examples of commonly owned U.S. Pat. No. 4,532,316 and adding in the reactor a phosphorus-based additive FYROLFLEX® RDP, phosphate ester in an amount of about 20% by weight. After the polyurethane resin was formed, 65 parts by weight of the polyurethane resin was mixed with 24 parts by weight of expandable graphite (the expandable graphite having an expansion of greater than 900 micrometers at 280° C. as determined by the TMA Expansion test) and an additional 17 parts by weight of another phosphorus-based flame retardant agent at 80° C. in a stirring vessel. The mixture was cooled and used as is.

### Adhesive 1

A flame retardant adhesive was prepared by first forming a resin according to commonly owned U.S. Pat. No. 4,532,316 and adding into the reactor a phosphorus-based flame retardant material, in an amount of about 20% by weight.

### Preparation of Laminate 1

A meltable layer of 100% 85 gsm recycled polyester knit fabric (item no. RNY04Dmb from Na Ya Plastics Corp., Taiwan) was laminated to carrier layer of an ePTFE membrane (available from W.L. Gore and Associates, Newark, Delaware, part #4410078). Heat Reactive material 1 was gravure printed onto the ePTFE membrane using a gravure roll having a pattern of repeating dots providing an adhesive coverage of about 40-45% and an adhesive laydown of 40-45 grams meter² (gsm). The meltable layer was placed on top of the carrier layer and rolled between the nip of two rollers. This laminate was placed on a roll to cure for at least 24 hours. A second layer of heat reactive material 1 was printed onto the exposed side of the carrier layer, that is, opposite the meltable layer using the same gravure as was previously used and a textile layer of 65% polyester/35% cotton (available from Ames Europe, Enschede, Netherlands, part no 310.300-000) was adhered to the second layer of the printed heat reactive material and the laminate was rolled between the nip of two rollers. This laminate was then placed on a roll to cure for at least 24 hours.

A fluorine based durable water repellent was applied to the meltable layer via a kiss coat process. Laminate 1 had a weight of 298 gsm.

### Preparation of Laminate 2

A meltable layer of 100% 85 gsm recycled polyester knit fabric (item no. RJ47Pmb, from Nan Ya Plastics Corp., Taiwan) was laminated to carrier layer of an ePTFE membrane (available from W.L. Gore and Associates, Newark, Delaware, part #4410078). Heat Reactive material 1 was gravure printed onto the ePTFE membrane using a gravure roll having a pattern of repeating dots providing an adhesive coverage of about 40-45% and an adhesive laydown of 40-45 grams meter². The meltable layer was placed on top of the carrier layer and rolled between the nip of two rollers. This laminate was placed on a roll to cure for at least 24 hours. A second layer of heat reactive material 1 was printed onto the exposed side of the carrier layer, that is, opposite the meltable layer using the same gravure as was previously used and a knit textile layer of 60% viscose/40% polyester (available from Borgini, Italy, part no. 14001) was adhered to the second printed layer of heat reactive material and the laminate was rolled between the nip of two rollers. This laminate was then placed on a roll to cure for at least 24 hours

A fluorine based durable water repellent was applied to the meltable layer via a kiss coat process. Laminate 2 had a weight of 252 gsm.

### Preparation of Laminate 3

A meltable layer of 100% 85 gsm polyester woven fabric (item no. RJ47Pmb, from Nan Ya Plastics, Taiwan) was laminated to carrier layer of an ePTFE membrane (available from W.L. Gore and Associates, Newark, Delaware, part #4410078). Heat Reactive material 1 was gravure printed onto the ePTFE membrane using a gravure roll having a pattern of repeating dots providing an adhesive coverage of about 40-45% and an adhesive laydown of 40-45 grams/meter². The meltable layer was placed on top of the carrier layer and rolled between the nip of two rollers. This laminate was placed on a roll to cure for at least 24 hours. A second layer of heat reactive material 1 was printed onto the exposed side of the carrier layer, that is, opposite the meltable layer using the same gravure as was previously used and a knit textile layer of 60% viscose/40% polyester (available from Borgini, Italy, part no. 14001) was adhered to the second printed layer of heat reactive material and the laminate was rolled between the nip of two rollers. This laminate was then placed on a roll to cure for at least 24 hours.

A fluorine based durable water repellent was applied to the meltable layer via a kiss coat process. Laminate 3 had a weight of 251 gsm.

### Preparation of Laminate 4

A meltable layer of 100% polyester woven textile having a weight of 70 gsm (style #751125, available from Milliken, Spartanburg, South Carolina), was laminated to a carrier layer of an ePTFE membrane having a weight of 20 gsm (part #10898200, available from W.L. Gore and Associates, Inc., Newark, Delaware). Heat reactive material 1 was gravure printed onto the ePTFE membrane using a gravure roll having a pattern of repeating dots and providing an adhesive coverage of about 55-60% and an adhesive laydown of 70-75 gsm. A second layer of heat reactive material 1 was printed onto the exposed side of the carrier layer, that is, opposite the meltable layer using a gravure roll having a pattern of repeating dots and providing an adhesive coverage of about 40-45% and an adhesive laydown of 40-45 gsm and a textile layer of 50% cotton/50% polyester knit (style #6336, available from Sextet Fabrics, Inc., New York, New York) was adhered to the second printed layer of heat reactive material and the laminate was rolled between the nip of two rollers. This laminate was placed on a roll to cure for at least 24 hours.

### Preparation of Laminate 5

A meltable layer of 100% polyester woven textile having a weight of 70 gsm (style #751125, available from Milliken, Spartanburg, South Carolina), was laminated to a carrier layer of an ePTFE membrane (made according to the teachings described in U.S. Pat. No. 9,782,947). Heat Reactive material 1 was gravure printed onto the ePTFE membrane using a gravure roll having a pattern of repeating dots and providing an adhesive coverage of about 55-60% and an adhesive laydown of 70-75 gsm. A second layer of heat reactive material 1 was printed onto the exposed side of the carrier layer, that is, opposite the meltable layer using a gravure roll having a pattern of repeating dots and providing an adhesive coverage of about 40-45% and an adhesive laydown of 40-45 gsm and a textile layer of 50% cotton/50% polyester knit (style #6336, available from Sextet Fabrics, Inc., New York, New York) was adhered to the second printed layer of heat reactive material and the laminate was rolled between the nip of two rollers. This laminate was placed on a roll to cure for at least 24 hours. Laminate #5 had a weight of 306 gsm and was used as is.

### Preparation of Comparative Laminate A

A meltable layer of 100% 151 gsm polyester blend 50% PET/50% PBT woven twill fabric (item no. SKOL004, available from Toray Textiles Europe Ltd., U.K.) was laminated to carrier layer of an ePTFE membrane (available from W.L. Gore and Associates, Newark, Delaware, part #4410078). Heat Reactive material 1 was gravure printed onto the ePTFE membrane using a gravure roll having a pattern of repeating dots providing an adhesive coverage of about 40-45% and an adhesive laydown of 40-45 grams meter². The meltable layer was placed on top of the carrier layer and rolled between the nip of two rollers. This laminate was placed on a roll to cure for at least 24 hours. A second layer of heat reactive material 1 was printed onto the exposed side of the carrier, that is, opposite the meltable layer using the same gravure as was previously used and a 93 gsm textile layer of TWARON® aramid/FR viscose/nylon (item no. 12634, available from Fuchshuber Techno-Tex GmbH. Lichtenstein, Germany) was placed on the carrier layer and the laminate was rolled between the nip of two rollers. This laminate was then placed on a roll to cure at least 24 hours.

A fluorine based durable water repellent was applied to the meltable layer via a kiss coat process. Comparative Laminate A had a weight of 302 gsm.

### Preparation of Comparative Laminate B

A meltable layer of 100% polyester woven textile having a weight of 70 gsm (style #751125, available from Milliken, Spartanburg, South Carolina), was laminated to a carrier layer of an ePTFE membrane having a weight of 20 gsm (part #10898200, available from W.L. Gore and Associates, Inc., Newark, Delaware). Heat Reactive material 1 was gravure printed onto the ePTFE membrane using a gravure roll having a pattern of repeating dots and providing an adhesive coverage of about 55-60% and an adhesive laydown of 70-75 gsm. The meltable layer was placed on top of the carrier layer and rolled between the nip of two rollers. This laminate was placed on a roll to cure for 48 hours. A layer of adhesive 1 was printed on the exposed side of the carrier layer, that is, opposite the meltable layer using a gravure having a repeating pattern of dots and providing an adhesive coverage of 40-45% and an adhesive laydown of 7-10 gsm and a 63 gsm knit textile comprising 40% modacrylic, 30% CONEX, and 30% Lyocell (available as style #SD 2376.00, from SSM Industries, Spring City, Tennessee) was adhered to the second printed layer of heat reactive material and the laminate was rolled between the nip of two rollers. The comparative laminate B was then placed on a roll to cure for at least 24 hours. Comparative Laminate B had a weight of 234 gsm.

Preparation of Comparative laminate C

A meltable layer of 100% polyester woven textile having a weight of 70 gsm (style #751125, available from Milliken, Spartanburg, South Carolina), was laminated to a carrier layer of an ePTFE membrane having a weight of 20 gsm (part #10898200, available from W.L. Gore and Associates, Inc., Newark, Delaware). Heat Reactive material 1 was gravure printed onto the ePTFE membrane using a gravure roll having a pattern of repeating dots and providing an adhesive coverage of about 55-60% and an adhesive laydown of 70-75 gsm. The meltable layer was placed on top of the carrier layer and rolled between the nip of two rollers. This laminate was placed on a roll to cure for 48 hours. A layer of adhesive 1 was printed on the exposed side of the carrier layer, that is, opposite the meltable layer using a gravure having a repeating pattern of dots and providing an adhesive coverage of 40-45% and an adhesive laydown of 7-10 gsm and a textile layer of 50% cotton/50% polyester knit (style #6336, available from Sextet Fabrics, Inc., New York, New York) was adhered to the second printed layer of heat reactive material and the laminate was rolled between the nip of two rollers. This laminate was placed on a roll to cure for at least 24 hours. Comparative laminate C had a weight of 242 gsm.

### Preparation of Comparative Laminate D

A meltable layer of 100% polyester woven textile having a weight of 70 gsm (style #751125, available from Milliken, Spartanburg, South Carolina), was laminated to a carrier layer of an ePTFE membrane having a weight of 20 gsm (part #10898200, available from W.L. Gore and Associates, Inc., Newark, Delaware). Heat Reactive material 1 was gravure printed onto the ePTFE membrane using a gravure roll having a pattern of repeating dots and providing an adhesive coverage of about 55-60% and an adhesive laydown of 70-75 gsm. The meltable layer was placed on top of the carrier layer and rolled between the nip of two rollers. This laminate was placed on a roll to cure for 48 hours. A layer of adhesive 1 was printed on the exposed side of the carrier layer, that is, opposite the meltable layer using a gravure to provide about 40-45% area coverage and an adhesive laydown of 40-45 gsm and a textile layer of 50% cotton/50% polyester knit (style #6336, available from Sextet Fabrics, Inc., New York, New York) was adhered to the second printed layer of heat reactive material and the laminate was rolled between the nip of two rollers. This laminate was placed on a roll to cure for at least 24 hours. Comparative Laminate D had a weight of 269 gsm.

Data Table 1

| | Laminate example | | | | | | | | |
|---|---|---|---|---|---|---|---|---|---|
| | 1 | 2 | 3 | 4 | 5 | A | B | C | D |
| Weight (gsm) | 298 | 252 | 251 | 272 | 308 | 302 | 234 | 242 | 269 |
| MVTR | 5200 | 10052 | 8899 | 9163 | 3949 | 12383 | 10837 | 10760 | 7104 |
| ATPV | | | | 29.5 | 51 | | 16.7 | 34.85 | 32.04 |
| (cal/cm²) | | | | | | | | | |
| Vertical Flame/ | 28.9 | 14.6 | 0.5 | 0.6 | 0.6 | 45.8 | 0.36 | 31.3 | 30.5 |
| Afterflame - | | | | | | | | | |
| warp (seconds) | | | | | | | | | |
| Vertical Flame/ | 4.3 | 0.4 | 0.5 | 0.6 | 0.6 | 7.2 | 0.5 | 22.1 | 30.4 |
| Afterflame - | | | | | | | | | |
| weft (seconds) | | | | | | | | | |
| Vertical Flame/ | 4.5 | 2.0 | 1.9 | 1.4 | 1.2 | 2.4 | 3.6 | 14.5 | 15.0 |
| Char Length - | | | | | | | | | |
| warp (cm) | | | | | | | | | |
| Vertical Flame/ | 1.6 | 1.7 | 1.9 | 1.5 | 1.3 | 1.9 | 5.4 | 10.6 | 21.7 |
| Char Length - | | | | | | | | | |
| weft (cm) | | | | | | | | | |
| Arc Box test | No | No | No | No | No | No | Yes | No | No |
| Excess of Stoll | | | | | | | | | |
| curve? | | | | | | | | | |
| Arc Box test - | 0 | 2.2 | 0 | 1.9 | 0 | 0.8 | 0.35 | 1.96 | 0.39 |
| burn time | | | | | | | | | |
| (secs, avg) | | | | | | | | | |
| Arc Box test - | Yes | Yes | Yes | No | No | No | No | No | No |
| hole formation | | | | | | | | | |
| Arc Box test - | Fail | Fail | Fail | Pass | Pass | Pass | Fail | Pass | Pass |
| pass/fail | | | | | | | | | |
| Horizontal flame | No | No | No | No | No | | No | No | No |
| (face) - afterflame | | | | | | | | | |
| (secs, avg) | | | | | | | | | |
| Horizontal flame | No | No | No | No | No | No | No | No | No |
| (face) - afterglow | | | | | | | | | |
| Horizontal flame | No | No | No | No | No | No | No | No | No |
| (face) - hole | | | | | | | | | |
| formation | | | | | | | | | |
| Horizontal flame | No | No | No | No | No | No | No | No | No |
| (face) - flaming | | | | | | | | | |
| debris? | | | | | | | | | |
| Horizontal flame | No | No | No | No | No | No | No | No | No |
| (face) - flaming | | | | | | | | | |
| to upper or | | | | | | | | | |
| vertical edge? | | | | | | | | | |
| Horizontal flame | No | No | No | No | No | No | No | 90 | 90 |
| (back) - afterflame | | | | | | | | | |
| (secs, avg) | | | | | | | | | |
| Horizontal flame | No | No | No | No | No | No | No | No | No |
| (back) - afterglow | | | | | | | | | |
| Horizontal flame | No | No | No | No | No | No | No | Yes | Yes |
| (back) - hole | | | | | | | | | |
| formation? | | | | | | | | | |
| Horizontal flame | No | No | No | No | No | No | No | Yes | Yes |
| (back) - flaming | | | | | | | | | |
| debris? | | | | | | | | | |
| Horizontal flame | | | | No | No | | No | No | No |
| (back) - flaming | | | | | | | | | |
| to upper or | | | | | | | | | |
| vertical edge? | | | | | | | | | |
| Edge Ignition - | | | | No | No | | No | 60 | 80 |
| afterflame | | | | | | | | | |
| (secs, avg) | | | | | | | | | |
| Edge Ignition - | | | | No | No | | No | No | No |
| afterglow | | | | | | | | | |
| Edge Ignition - | | | | No | No | | No | Yes | Yes |
| hole formation? | | | | | | | | | |
| Edge Ignition - | | | | No | No | | No | Yes | Yes |
| flaming debris? | | | | | | | | | |
| Edge Ignition - | | | | No | No | | No | Yes | Yes |
| flaming to upper | | | | | | | | | |
| or vertical edge? | | | | | | | | | |

The results in Table 1 show that the inventive examples can provide a combination of high arc flash protection values, low afterflame and low char length, while still providing relatively low laminate weights when compared to the comparative examples that generally only provide either one or the other of arc protection or afterflame measurements (afterflame and/or char length).

1. A laminate comprising:
a) a first textile layer;
b) a first layer of a heat reactive material;
c) a carrier layer;
d) a second layer of a heat reactive material; and
e) a second textile layer;
wherein the first and second layers of heat reactive material each independently comprise a polymer resin and expandable graphite;
wherein the first layer of heat reactive material is between the first textile layer and the carrier layer and the second layer of heat reactive material is between the carrier layer and the second textile layer.

2. The laminate of claim 1 wherein each layer of heat reactive material is independently applied in a continuous manner or a discontinuous manner.

3. The laminate of claim 1 wherein each layer of heat reactive material is in a form of a pattern of discontinuous dots, lines or grids.

4. The laminate of claim 1 wherein at least one of the first and the second layer of heat reactive material comprises a flame retardant material.

5. The laminate of claim 1 wherein the first textile layer and the second textile layer each comprise at least one meltable fiber.

6. The laminate of claim 1 wherein the first textile layer comprises a combination of meltable fibers and nonmeltable fibers including a percentage by weight of the nonmeltable fibers that is in a range of from 1 to 99% and a percentage by weight of the meltable fibers that is in a range of from 1 to 99%, wherein the percentages by weight are based on a total weight of the fibers in each textile layer.

7. The laminate of claim 1 wherein the layers a) and c) are bonded to each other using the first layer of heat reactive material and the layers c) and e) are bonded to each other using the second layer of heat reactive material.

8. The laminate of claim 1 wherein the first layer of heat reactive material covers greater than or equal to 25% of a surface of the first textile layer.

9. The laminate of claim 1 wherein the second layer of heat reactive material covers greater than or equal to 25% of a surface of the second textile layer.

10. The laminate of claim 1 wherein the expandable graphite expands at least about 900 micrometers upon heating to about 280° C., as measured in a TMA expansion test.

11. The laminate of claim 1, wherein the carrier layer comprises fluoropolymer, polyimide, silicone, polyurethane, polytetrafluoroethylene (PTFE), expanded PTFE (ePTFE) or a combination thereof.

12. The laminate of claim 1, wherein the laminate further comprises one or more additional layers of heat reactive material and textile layers, wherein each subsequent additional layer is positioned adjacent to the textile layer.

13. The laminate of claim 1, wherein the second textile comprises meltable fibers and is considered a non-meltable/no-drip textile according to a melting and thermal stability test.

14. A method of forming the laminate of claim 1, comprising;
i) adhering the first textile layer to the carrier layer with the first heat reactive material to form a precursor laminate; and
ii) adhering the precursor laminate to the second textile layer with the second heat reactive material.

15. The use of the laminate of claim 1 to increase thermal protective performance of an article comprising the laminate against an arc discharge of up to 100 cal/cm2.

16. An article comprising the laminate of claim 1.

17. The article of claim 16, wherein the article is a garment.
